(19) United States
(12) Patent Application Publication
(10) Pub. No.: US 2023/0004908 A1
(43) Pub. Date: Jan. 5, 2023

(54) INFORMATION MANAGEMENT SYSTEM OF LAWN PROFILE DATA

(71) Applicant: TEXAROBA TECHNOLOGY INC., Plano, TX (US)

(72) Inventor: Jia SONG, Tulsa, OK (US)

(73) Assignee: TEXAROBA TECHNOLOGY INC., Plano, TX (US)

(21) Appl. No.: 17/801,487

(22) PCT Filed: Feb. 25, 2021
(86) PCT No.: PCT/US2021/019741

§ 371 Date: Aug. 22, 2022

Related U.S. Application Data
(60) Provisional application No. 62/981,577, filed on Feb. 26, 2020.
(60) Provisional application No. 62/981,585, filed on Feb. 26, 2020.
(60) Provisional application No. 62/991,106, filed on Mar. 18, 2020.

(51) Int. Cl. G06Q 10/06; G06Q 10/04; A01D 34/00; G05D 1/02; H04W 4/40

(52) U.S. Cl. CPC G06Q 10/06316; G06Q 10/04; A01D 34/008; G05D 1/0219; H04W 4/40; A01D 2101/00

(57) ABSTRACT

This invention relates to an information management system of lawn profile data. It comprises a lawn profile information collecting tool for collecting information any pieces of lawns that need mowing jobs; wherein the lawn profile information collecting tool includes a data converter for converting such information to lawn profile data, and data processer for processing the lawn profile data locally into suitable formats and categories for uploading; a mobile device of a user being in communication with the lawn profile information collecting tool to receive the processed lawn profile data; a remote information processing center being in communication with the mobile device and the lawn profile information collecting tool to receive and process requests from the mobile device to upload the lawn profile data; wherein the remote information processing center includes a data storage unit for storing the lawn profile data for usage thereof by a designated lawn mower to perform mowing job, that is, using the stored lawn profile data associated with the particular piece of lawn as requested.

### CROSS-REFERENCE TO RELATED APPLICATIONS

The present application claims priorities to U.S. Provisional Application No. 62/981,577, filed on Feb. 26, 2020; U.S. Provisional Application No. 62/981,585, filed on Feb. 26, 2020; and U.S. Provisional Application No. 62/991,106, filed on Mar. 18, 2020; the disclosures of which are incorporated herein by reference in the entirety as part of the present application. This application also relates to and claims priority to PCT/US21/016951, filed on Feb. 5, 2021, which claims priority to U.S. Provisional Application No. 62/971,805, filed on Feb. 7, 2020.

### FIELD OF THE INVENTION

The present invention relates to an information management system of lawn profile data, that is, collection, storage, distribution, and usage of data of lawn profiles directed to any piece of lawns around the world; and in particular, such data can be stored in cloud, and be accessible through any available wireless networks and/or internet. Moreover, such data can be updated through uploading from designated users' devices, or rather mobile devices.

### BACKGROUND OF THE INVENTION

In order to mow a piece of lawn, a robotic mower would better have or learn certain information or knowledge about the particular piece of lawn in advance or ahead of time, i.e., before starting the mowing jobs. At present, most of robotic lawn mowers in the market use a preset-up border wire or perimeter wire. The preset-up border wire determines or defines the outline or boundary of the lawn to be cut or mowed. The robotic lawn mower will not cross the boundary or the cutting border. This is the only information or knowledge as preset for the robotic lawn mower. The lawn mower may deploy a random path method to go around the lawn and cut grass wherever the mower goes over the lawn within the boundary defined by the border wire. When the mower detects or bumps into an object or any obstacle in its moving path, the mower will stop and turn into a different direction, and the new direction is still random, depending on how the mower bumps into the object or obstacle. Therefore, this type of robotic lawn mower cannot guarantee to mow the entire lawn efficiently because it is always uncertain as to where the mower may go upon bumping on the object or obstacle or the border wire, and because it would need to preset up a relatively long time for mowing. Thus, it is generally a time-consuming process, due to the lack of certainty as to where the mower goes or how the mower may go in order to cover the entire piece of lawn, without much duplicate work or missing areas.

Another type of robotic lawn mower has been proposed in 2019, and may be referred to as border beacons technology. It gives up the outdated perimeter or border wire technology, and uses wireless beacons technology to determine boundaries of a piece of lawn, to localize its position and to navigate with respect to the lawn. This should be a better type of robotic lawn mowers over the mowers using border wire, and it may cut grass more efficiently and do a better mowing job than the border wire technology. However, the setup process is complicated by planting beacons around the yard or lawn. A joystick is used, with which a person needs to drive the robot around the perimeter and also drive it around any areas inside the yard, that is, the areas to avoid, such as flower beds or fishponds. This method should work fine with personal or individual lawns where the beacons are set up right and correctly at the very first time. However, any information or knowledge of the personal or individual lawns cannot be shared with other mowers. It is kept individually or personally with the one mower which was initially setup to do the job. Each of other lawn mowers may be reset independently, if a new mower is needed to do the mowing job on the lawn.

In today's world, AI technology and big data are used to enhance and/or back up lots of things, and to develop many new things, in addition to the widely used GPS and Google maps, etc. Besides, it is generally true that any individual lawns or any piece of lands may not change quite often, and tend to stay as is so long as surrounding buildings or other fixtures are kept unchanged over time; and on the other hand, a lawn mower may not be used for a too long period of time, and it would need to be replaced for a new one from time to time. Therefore, it is desirable that the information and/or knowledge of individual lawns may be shared so that any other or new lawn mowers may receive the information and/or knowledge of any piece of lawns without too much trouble of presetting or installment of border wire or beacons. Other conditions of lawns may also affect mowing jobs, such as, wetness of grass, slopes of the lawns or any instant changes of those conditions of the lawn. That is to say any robotic lawn mower, after acquiring the needed information and/or knowledge about the lawn, should be able to perform the mowing job without any training, and even several robots or robotic lawn mowers are capable of collaboratively performing a big mowing job for a relatively big or even huge piece of lawn. It is believed that none of the robotic lawn mowers currently on the market or robotic technology has ever addressed such issues.

### SUMMARY OF THE INVENTION

Accordingly, an object of the present invention is to identify basic and/or essential lawn information and/or knowledge to create lawn profile data, reflecting all needs for efficiently performing mowing jobs for any types of robotic lawn mowers or lawn robots.

It is another object of the present invention to create a lawn profile data information management system, that may collect, store, transfer, distribute, and/or use lawn profile data quantifiably; and such lawn profile data may be capable of uploading, downloading, updating from time to time, and may be transferable from one robot to another or shared among robots, i.e., between or among robotic lawn mowers.

According to the present invention, lawn profile data may use an XML based language to describe the information and/or knowledge of lawn profile, such as sizes, shapes, and slopes, etc., reflecting the conditions of any lawns. According to the present invention, the lawn profile data are described in details as to lawn profile data structure, syntax, and data hierarchy hereinafter.

According to the present invention, a lawn profile data information management system comprises generally at least a lawn profile information collecting tool for collecting information and/or knowledge of any pieces of lawns that would be necessary for performing mowing jobs on the lawns; wherein the lawn profile information collecting tool includes a data converter for converting the collected information and/or knowledge of lawns to lawn profile data, and includes a data processor for processing the lawn profile data locally into suitable formats and categories; at least a mobile device of a user or operator being in communication with the lawn profile information collecting tool to receive the processed lawn profile data; a remote information processing center being in communication with the mobile device and the lawn profile information collecting tool to receive and process any requests from the mobile device; wherein the remote information processing center includes a data storage unit for storing the lawn profile data for usage and/or application by a designated lawn mower to perform a mowing job on a particular piece of lawn, that is, using the stored lawn profile data associated with the particular piece of lawn if so requested. Alternatively, the data storage unit is not part of the remote information processing center, but is operative therewith. The mobile device communicates with and sends a request to the remote information processing center for updating the lawn profile data from time to time in response to any update need or a request for using the lawn profile data for performing a mowing job on a particular piece of lawn. The remote information processing center responds to such a request from the mobile device which is used by an expected user or operator of a lawn profile collecting tool or robotic lawn mower or lawn robot, verifying the request, permitting uploading of any updated lawn profile data, and/or downloading the requisite lawn profile data to the lawn mower or robot of the expected user. Once the requisite lawn profile data is downloaded to the expected user for the lawn mower or lawn robot, the lawn mower may then perform the mowing jobs on the designated piece of lawn.

According to the present invention, the collecting tool for collecting information and/or knowledge of lawns, the data converter for converting such information and/or knowledge of lawns to lawn profile data, and the data processor for processing the lawn profile data locally into suitable formats and categories may be generally integrated in a local apparatus, such as, a lawn profile information collector, and they may also be provided as part of a robotic lawn mower or lawn robot. The remote information processing center and the data storage unit may be a cloud-based service provider or providers that are operably together. The mobile devices may be any users' hand-held devices, such as smart phones equipped with app that can communicate wirelessly with the information processing center, and with the lawn profile information collector, as well as with the robotic lawn mower or lawn robot.

According to the present invention, the lawn mower may be equipped with a sensing and detecting system that will detect any actual conditions of the grass of the lawn or the conditions of the lawn itself, and such detected conditions will be processed locally through the equipped data convertor and data process er. Those processed lawn profile data may be used to update the downloaded lawn profile data and then may be sent, through the authorized movable device, to the remote information processing center to update the lawn profile data therein, especially when such conditions are not incidental or instantaneous, but permanent.

A separate lawn profile information collector which is not part of the robotic lawn mower is invented and may be used to automatically collect the information and/or knowledge of lawns as lawn profile raw or initial data, and is addressed in details in one of the related patent applications, as indicated in the cross-reference section above. Before mowing a piece of lawn, such initial or raw data of a specific piece of lawn will be collected, processed and communicated through a mobile device of a verified and authorized user or operator to the remote information processing center, and kept in the storage unit there for future use.

According to the present invention, the lawn profile date kept in the remote information processing center or rather in a cloud storage may be in an encrypted format for secured data transmission. Usually, upon receipt of a request from a mobile device of a user of a robotic lawn mower that is verified by the information processing center for authorization, the requisite lawn profile data will be transmitted in encrypted format and downloaded to the designated robotic lawn mower or any lawn robots that would need such data to operate together, that is, after proper verification, the lawn profile data information management system will confirm that it is a justifiable job to be performed by the authorized user of the lawn mower or the robot.

The lawn profile data information management system of the present invention may be better understood in the following detailed description in connection with the accompanying drawings.

### BRIEF DESCRIPTION OF DRAWINGS

FIG. 1 illustrates a general lawn profile data information management system of the present invention.

FIG. 2 shows overall data structure for lawn profile information and/or knowledge.

FIG. 3 illustrates the hierarchy of four types of the lawn profile data.

FIG. 4 shows the flow chart of collecting and unloading of initial lawn profile data.

FIG. 5 illustrates the flow of lawn profile data when a mowing job is requested.

FIG. 6 and FIG. 7 show the examples of information and/or knowledge of lawns for the lawn profile data in connection with a piece of residential lawn.

### DETAILED DESCRIPTION OF THE INVENTION

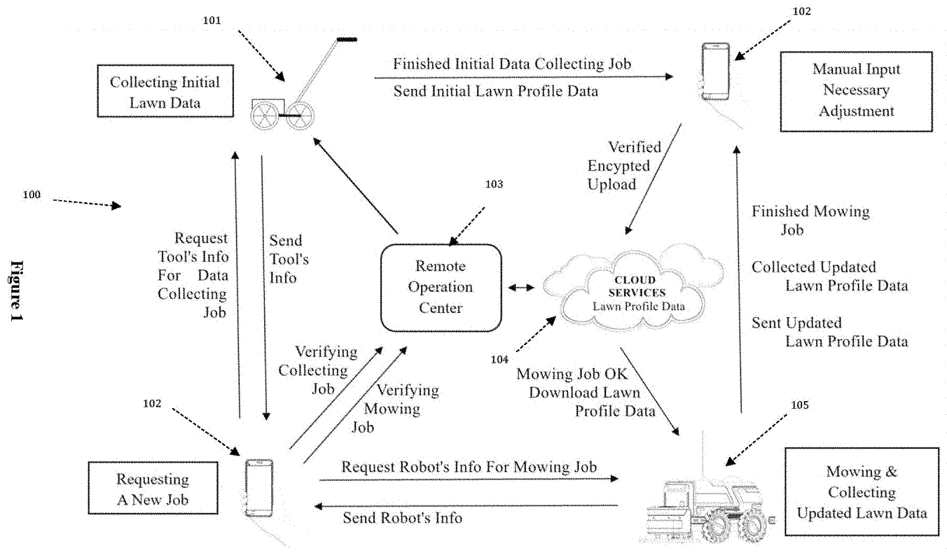

The lawn profile data information management system 100 is illustrated generally in FIG. 1, which comprises a lawn profile information collecting tool 101 for collecting information and/or knowledge of any pieces of lawns that are necessary for performing mowing jobs; wherein the lawn profile information collecting tool 101 includes a data converter for converting such information and/or knowledge of lawns to lawn profile data, and a data processer for processing the lawn profile data locally into suitable formats and categories for uploading; at least a mobile device 102 of a user or operator being in communication with the lawn profile information collecting tool 101 to receive the processed lawn profile data; a remote information processing center 103 being in communication with the mobile device 102 and the lawn profile information collecting tool 101 to receive and process any requests from the mobile device 102 to upload the lawn profile data; wherein the remote information processing center 103 includes a data storage unit 104 for storing the lawn profile data for usage or application by any designated lawn mower 105 to perform mowing job on a particular piece of lawn, that is, using the stored lawn profile data associated with the particular piece of lawn if so requested. Alternatively, the data storage unit 104 is not part of the remote information processing center 103, but is operative with the information processing center 103. The mobile device 102 communicates with and sends a request to the remote information processing center 103 for updating any updated lawn profile data from time to time in response to any update need or sends a request for using the lawn profile data for performing a mowing job on a particular piece of lawn. The remote information processing center 103 responds to any of such requests from the mobile device 102 which may be used by an expected user or operator of either the lawn profile collecting tool 101 or a robotic lawn mower or lawn robot 105, verifying the request, permitting uploading of the updated lawn profile data, or downloading the requisite lawn profile data to the lawn mower or robot 105 of the expected user of the lawn mower or lawn robot. Once the requisite lawn profile data is downloaded to the user of the lawn mower or lawn robot, the lawn mower may then perform the mowing jobs on the designated piece of lawn.

As seen in FIG. 1, the lawn profile collecting tool 101 for collecting information or knowledge of lawns, the data converter for converting such information and/or knowledge of lawns to lawn profile data, and the data processer for processing the lawn profile data locally into suitable formats and categories may be formed and integrated as a separate lawn profile information collector 101 that collects and creates any initial lawn profile data or updated lawn profile data; and they may be provided as part of a robotic lawn mower or lawn robot 105, that would normally collect and create updated lawn profile data. Alternatively, a lawn profile data processing apparatus (not illustrated in FIG. 1) may be attached to and/or work with any other kind of lawn robot or robotic lawn mower which otherwise does not have such capacity of processing lawn profile data. Such an independent data processing apparatus may be used for receiving downloaded lawn profile data for performing mowing jobs on lawns and used to the aforesaid uploading of any lawn profile data, if the lawn robot is equipped with the independent lawn profile data processing apparatus. The remote information processing center 103 and the data storage unit 104 may be integrated or separated as either a central processing server or a plurality of data processing servers working cooperatively together. They could be based on cloud services. The mobile devices may be users' hand-held devices, such as smart phones or pads, so long as they can communicate wirelessly with the remote information processing center, and the lawn profile information collecting tool 101, as well as with the robotic lawn mower or lawn robot 105.

For usage or application of the lawn profile data, the desired lawn profile data for performing a mowing job on a particular piece of lawn will be downloaded to a designated robotic lawn mower or lawn robot 105 upon a working request sent from the mobile device 102 of the user or operator who would activate or operate the lawn mower 105 upon checking and verifying as well as confirming the data. Also, the lawn profile data may be downloaded to an independent data processing apparatus, that is, it is not integrated as part of, but attachable to a normal lawn robot or the robotic lawn mower, which otherwise does not have the capacity of using and processing lawn profile data used in the information management system of lawn profile data according to the present invention. In any event, the working request is usually sent from the mobile device 102 of a user or operator or user's hand-held device. The lawn mower 105 is activated by the downloading of the requisite lawn profile data upon such a operative working request. In addition, any updates of lawn profile data may be transmitted into or received by the mobile device 102, and then be uploaded through the mobile device 102 to the remote information processing center 103, especially those updates that are determined as reflecting permanent changes of the lawn, rather than incidental or instantaneous changes. Usually, such changes of the lawn profile information may be sensed and detected by the lawn mower or lawn robot 105 during the mowing jobs.

Basically, the information or knowledge about a piece of lawn may include the location identity of the piece of lawn, such as its address, GNSS coordinates, etc. as used in GPS system; type or kind of the lawn or categories of the lawn, such as residences, parks, roadside, or golf course; and areas of the lawn as zone information as the lawn being divided; and so on. Those information are defined as lawn profile information or knowledge. Accordingly, the information or knowledge of the lawn profile may be converted into internal lawn model, that would be suitable to reflect the pieces of lawns for future mowing or caring jobs. The lawn profile data information management system 100 is then constructed to convert the lawn profile information to lawn profile data and to keep or store such lawn profile data for future use.

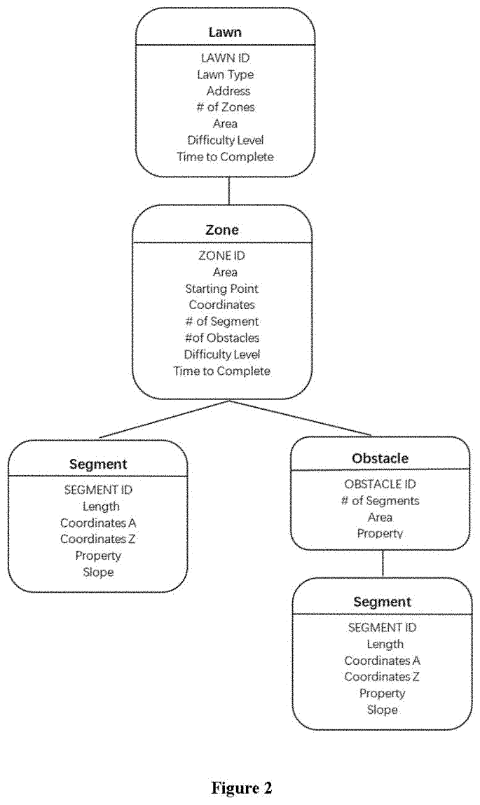

For the information management system of lawn profile data of the present invention, there may be generally four types of lawn profile data as shown in FIG. 2, i.e., lawn, zone, obstacle, and segment. The data of lawn is the highest-level data which contains one or more zones. The lawn data should also contain the identity of the lawn, difficulty level of the lawn and the time to complete mowing or caring jobs of the lawn.

A zone is a sub-area of the lawn and is normally separated from other sub-areas. In each of zones, there may be a number of non-cuttable areas, known as obstacles, and a number of boundaries, known as segments. Each of obstacles also has segments to define its boundaries. A zone data should also contain the identity, area, coordinates, a starting point, possible obstacles, and segments. The zone data further contains difficulty level and time to complete mowing or caring jobs of the zone. Moreover, each of zone segment data may contain the identify, length, coordinates, property and slope thereof.

An obstacle data may contain the identity, area, property and a number of segments. The segment of the obstacle data may contain the identity, length, coordinates, property and slope thereof, similar to the zone segment data.

### Language and Data Structure:

As an embodiment, the lawn profile data is expressed in an XLM based language, that describes the lawn properties as mentioned above, i.e., the lawn, zones of the lawn, segments of each zone, any obstacles of in the zone, and the segments of the obstacle. General format of the lawn profile may be as follows:

```
<LAWN ID=“ ” TYPE=“ ” MEASUREMENT=“ ” ZONES=“ ” AREA=“ ” D-LEVEL=“ ” T-COMPLETE=“ ”>
  <ADDRESS></ADDRESS>
  <CITY></CITY>
  <STATE></STATE>
  <ZIP></ZIP>
  <COUNTRY></COUNTRY>
  <ZONE ID=“ ” STARTINGPOINT=“ ” OBSTACLES=“ ” SEGMENTS=“ ” AREA=“ ” D-LEVEL=“ ” T-COMPLETE=“ ”>
    < STARTINGPOINT LAT=“ ” LNG=“ ” H=“ ”>
    <OBSTACLE ID=“ ” SEGMENTS=“ ” AREA=“ ” PROPERTY=“ ”>
      <SEGMENT ID=“ ” LENGTH=“ ”LAT_A=“ ” LNG_A=“ ” H_A=“ ” LAT_Z=“ ” LNG_Z=“ ” H_Z=“ ”
    PROPERTY=“ ” SLOP=“ ”>
      ......
      <SEGMENT ID=“ ” LENGTH=“ ” LAT_A=“ ” LNG_A=“ ” H_A=“ ” LAT_Z=“ ” LNG_Z=“ ” H_Z=“ ”
    PROPERTY=“ ”SLOP=“ ”>
    </OBSTACLE>
    ......
    <OBSTACLE ID=“ ” SEGMENTS=“ ” AREA=“ ” PROPERTY=“ ”>
      <SEGMENT ID=“ ” LENGTH=“ ” LAT_A=“ ” LNG_A=“ ” H_A=“ ” LAT_Z=“ ” LNG_Z=“ ” H_Z=“ ”
    PROPERTY=“ ” SLOP=“ ”>
      ......
      <SEGMENT ID=“ ” LENGTH=“ ” LAT_A=“ ” LNG_A=“ ” H_A=“ ” LAT_Z=“ ” LNG_Z=“ ” H_Z=“ ”
    PROPERTY=“ ” SLOP=“ ”>
    </OBSTACLE>
    <SEGMENT ID=“ ” LENGTH=“ ” LAT_A=“ ” LNG_A=“ ” H_A=“ ” LAT_Z=“ ” LNG_Z=“ ” H_Z=“ ”
  PROPERTY=“ ” SLOP=“ ”>
    ......
    <SEGMENT ID=“ ” LENGTH=“ ” LAT_A=“ ” LNG_A=“ ” H_A=“ ” LAT_Z=“ ” LNG_Z=“ ” H_Z=“ ”
  PROPERTY=“ ” SLOP=“ ”>
  </ZONE>
  ......
  <ZONE ID=“ ” STARTINGPOINT=“ ” OBSTACLES=“ ” SEGMENTS=“ ” AREA=“ ” D-LEVEL=“ ” T-COMPLETE=“ ”>
    < STARTINGPOINT LAT=“ ” LNG=“ ” H=“ ”>
    <OBSTACLE ID=“ ” STARTINGPOINT=“ ” SEGMENTS=“ ” AREA=“ ” PROPERTY=“ ”>
      <SEGMENT ID=“ ” LENGTH=“ ” LAT_A=“ ” LNG_A=“ ” H_A=“ ” LAT_Z=“ ” LNG_Z=“ ” H_Z=“ ”
    PROPERTY=“ ” SLOP=“ ”>
      ......
      <SEGMENT ID=“ ” LENGTH=“ ” LAT_A=“ ” LNG_A=“ ” H_A=“ ” LAT_Z=“ ” LNG_Z=“ ” H_Z=“ ”
    PROPERTY=“ ” SLOP=“ ”>
    </OBSTACLE>
    ......
    <OBSTACLE ID=“ ” SEGMENTS=“ ” AREA=“ ” PROPERTY=“ ”>
      <SEGMENT ID=“ ” LENGTH=“ ” LAT_A=“ ” LNG_A=“ ” H_A=“ ” LAT_Z=“ ” LNG_Z=“ ” H_Z=“ ”
    PROPERTY=“ ” SLOP=“ ”>
      ......
      <SEGMENT ID=“ ” LENGTH=“ ” LAT_A=“ ” LNG_A=“ ” H_A=“ ” LAT_Z=“ ” LNG_Z=“ ” H_Z=“ ”
    PROPERTY=“ ” SLOP=“ ”>
    </OBSTACLE>
    <SEGMENT ID=“ ” LENGTH=“ ” LAT_A=“ ” LNG_A=“ ” H_A=“ ” LAT_Z=“ ” LNG_Z=“ ” H_Z=“ ”
  PROPERTY=“ ” SLOP=“ ”>
    ......
    <SEGMENT ID=“ ” LENGTH=“ ” LAT_A=“ ” LNG_A=“ ” H_A=“ ” LAT_Z=“ ” LNG_Z=“ ” H_Z=“ ”
  PROPERTY=“ ” SLOP=“ ”>
  </ZONE>
</LAWN>
```

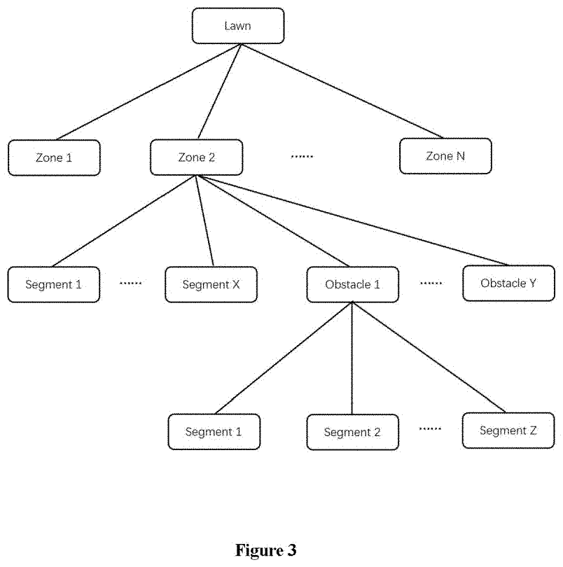

The lawn data, zone data, obstacle data, and segment data of the zone and obstacle are four types of data generally arranged in hierarchy as shown in FIG. 3. When the information or knowledge of lawns, i.e., lawn profiles, are measured and collected, such information or knowledge of lawns are converted into the aforesaid lawn profile data.

### Initial Data Collection and Formation

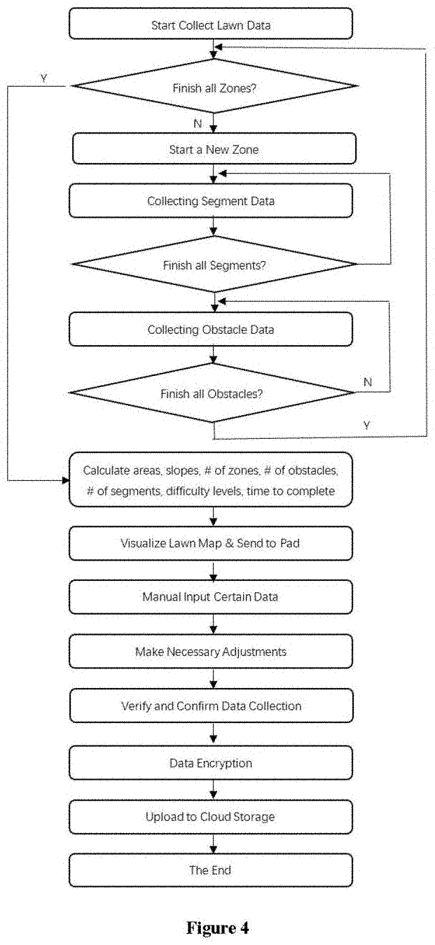

FIG. 4 shows the flow chart or procedure of collecting the information or knowledge of lawns and converting the same into the aforesaid data. Although the measurement tool or tools are disclosed in more details in another related patent application, the measurement of a piece of lawn will start generally to determine whether a metric or imperial unit system should be used for the particular piece of lawn because the lawn profile database system of the invention is intended to be used anywhere around the world, and the different unit systems may be used at different locations. Accordingly, it is necessary to determine which unit systems should be used for a particular piece of lawn. Then, such lawn information or knowledge will be converted to the lawn profile data.

A piece of lawn may be divided into a number of zones. There may be certain non-cuttable areas called Obstacles, such as a swimming pool, a pond, trees, gas meter, and so on. Those areas need to be marked so that lawn robots or robotic lawn mowers will avoid them while doing the jobs. Area is the sum of total cuttable areas. Difficulty level defines how easy to complete the mowing job from easiest to most difficult with a scale of 1 to 100. An assessment algorithm will evaluate all aspects of lawn profile to come up with a specific score about the particular piece of lawn. Time to complete is an estimate of how long it will take to complete the mowing job or caring job in terms of minutes. These two values of Difficulty level and Time to complete will be updated every time the lawn robots or robotic lawn mowers for mowing the particular piece of lawn so that the lawn profile data will become more and more accurate.

Each of zones has its ID or identity and a number of distinguishable sides, called SEGMENTS, each of segments may be described as start point, coordinate A, and end point, coordinate Z.

Obstacles are non-cuttable areas inside of a zone, e.g., a swimming pool or pond, trees, gas meter, and other things. The information of obstacles needs to be collected and marked in data model so that the lawn robots or mowers will not go there. Property describes the nature of the obstacle, such as flower bed, garden, and etc.

Segment has five aspects, length, coordinate A, coordinate Z, property, and slope. Length is the span of the segment measured by unit in Measurement tag. Coordinate A and coordinate Z are GPS or GNSS coordinates of both ends of the segment. Property is the description of the object next to the segment, on the other side of the lawn. Slope is the level difference of the segment in terms of degrees.

All of the initial data are collected and formed as shown in the flow chart of FIG. 4. Most of the data may be collected directly from the measurement of lawns. Other things are calculated from the collected data, i.e., areas, slopes, number of zones, number of obstacles, number of segments, difficulty levels, and time to complete. Difficulty level is the score that is assigned to each of lawns which indicates how hard to mow the lawn from 1 to 100 (i.e., from the easiest to the most difficult). Time to complete is an estimate of how long it may take to finish mowing the particular piece of lawn or a zone of the lawn.

As seen in FIG. 4, all zones of a piece of lawn will be measured and collected until completion of collection of all necessary information or knowledge of lawns; and then some adjustment or verification may be done, if so desired before the whole data pack is encrypted. Afterwards, the lawn profile data as encrypted will be uploaded to a remote storage unit, which may be likely cloud storage; and such lawn profile data is now ready for use by authorized user of a robotic lawn mower or lawn robot. All of the aforesaid functions are performed by the lawn profile data information management system as illustrated in FIG. 1.

### Data Usage or Application:

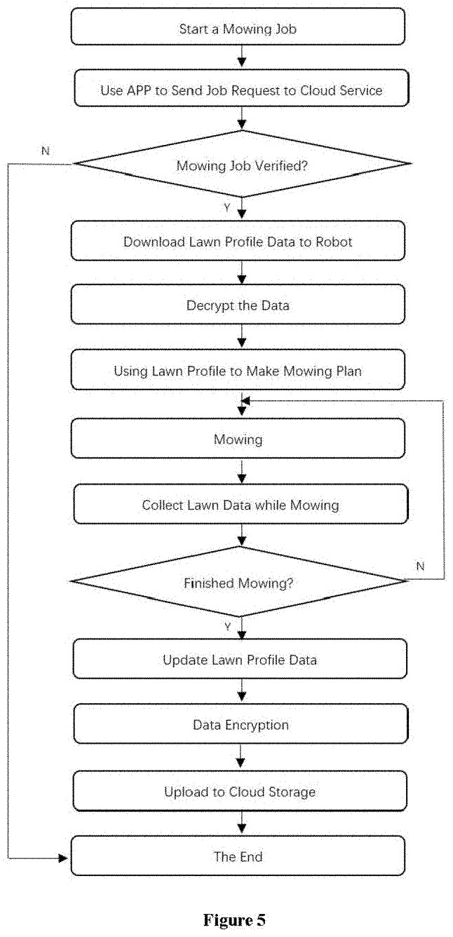

The uploaded and stored lawn profile data may be used upon a request from a user of a robotic lawn mower or lawn robot 105, through a mobile device 102 of the user; and the process of such a request and performance of the mowing job are illustrated in FIG. 5. A request for a mowing job may be sent from a user through a mobile device 102 or rather a hand-held device, such as Smartphone or pad. The request is sent to the remote information processing center 103, which will check and verify the authentication or authorization of the user and the lawn robot or robotic lawn mower 105 to be used through the mobile device 102 associated with the lawn robot or robotic lawn mower 105. After being verified as a correct job request, the lawn profile data of the specific piece of lawn to be mowed will be downloaded, e.g., from the cloud storage 104 to the lawn robot or robotic lawn mower 105 through the lawn data processing apparatus equipped or installed in the lawn robot or robotic lawn mower. The lawn robot will then use the lawn profile data to perform mowing job in accordance with an assigned mowing plan for each of zones of the specific piece of lawn.

The robotic lawn mower 105 may be equipped with sensing and detecting system that will detect and collect the actual conditions of the specific piece of lawn while mowing, and the actual conditions of the lawn will be converted into new data to update the lawn profile data as downloaded, as the assigned mowing plan, to the robotic lawn mower so that the mowing job may be performed with necessary adjustment to the original mowing plan to finish the mowing job better. When the robotic lawn mower 105 finishes the mowing, the updated lawn profile data will be uploaded to the cloud storage 104 for future use, especially when such updated lawn profile data reflects any permanent change of the lawn being mowed.

Before a lawn robot can download the lawn profile data, certain verifications must be done first, such as the location of the user of the robotic lawn mower 105, and the piece of lawn to be mowed. This will assure the downloading of correct lawn profile data as prestored in the cloud storage for the specific piece of lawn. Once the robotic lawn mower or lawn robot 105 can download the correct lawn profile data, the lawn robot or mower 105 will use the downloaded lawn profile data to build a mowing plan for the specific piece of lawn. According to the mowing plan, the lawn robot 105 will mow each of zones within its boundaries of the lawn, while it will avoid or not go into the obstacles within any of the zones of the specific lawn.

While mowing, the lawn robot or robotic lawn mower 105 will detect and collect the actual conditions of the lawn, as updates of lawn profile data. Again, the updates of lawn profile data may be used to adjust the mowing plan so as to adjust the mowing job. After finishing the mowing, the collected updates of the lawn profile data will be shown on the mobile device 102 or hand-held device, such as in an APP for the user to visualize or to see the updated lawn profile data and for the user to make any comments or further input or observation as adjustment about the lawn profile data, before uploading the update lawn profile data pack to the cloud storage or the storage unit of the remote information processing center.

### Examples of Specific Lawn Profile Data

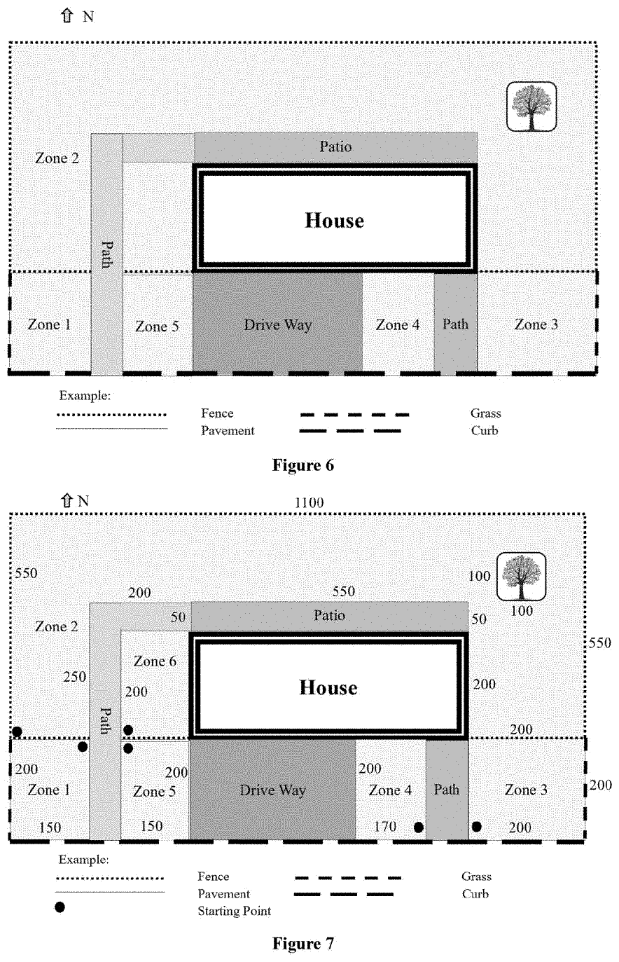

FIG. 6 shows how a specific piece of lawn may be expressed in lawn profile data, that is, all necessary aspects of information or knowledge of the piece of lawn to be expressed with the lawn profile data. The example here is a lawn of a residential property. However, all other lawns can be expressed in the same way as this example, that is, how the piece of lawn be divided and classified into the information or knowledge of the lawn as its entirety, zones of the lawn or grass, any obstacles of drive way, path, pavement, trees or fence, and segments of the zones and/or obstacles, as so categorized of lawn profile data as described hereinabove.

For instance, zone 1 as shown in FIG. 7 has four segments. The starting point is on the NORTHEAST corner of the zone 1. From the starting point, Segment 1 has a length of 200 feet and goes from north to south. The object next to Segment 1 is a cement pavement of a path. Segment 2 has a length of 150 feet and goes from east to west. The object next to Segment 2 is a curb. Segment 3 has a length of 200 feet and goes from south to north. The object next to Segment 3 is grass. Segment 4 has a length of 150 feet and goes from west to east. The object next to Segment 3 is a fence.

In another example, zone 2 as shown in FIG. 7 has ten segments and one obstacle. The starting point is on the SOUTHEAST corner of zone 2. From the starting point. Segment 1 has a length of 550 feet and goes from south to north. The object next to Segment 1 is a fence. Segment 2 has a length of 1100 feet and goes from west to east. The object next to Segment 2 is a fence. Segment 3 has a length of 550 feet and goes from north to south. The object next to Segment 3 is a fence. Segment 4 has a length of 200 feet and goes from east to west. The object next to Segment 5 is a fence. Segment 5 has a length of 200 feet and goes from south to north. The object next to Segment 5 is a wall. Segment 6 has a length of 50 feet and goes from south to north. The object next to Segment 6 is cement pavement of a patio. Segment 7 has a length of 550 feet and goes from east to west. The object next to Segment 7 is cement pavement of a patio. Segment 8 has a length of 200 feet and goes from east to west. The object next to Segment 6 is cement pavement of a path. Segment 9 has a length of 250 feet and goes from north to south. The object next to Segment 9 is cement pavement of a path. Segment 10 has a length of 150 feet and goes from east to west. The object next to Segment 10 is a fence.

There is an obstacle inside of zone 2. The obstacle has four segments. Segment 1 has a length of 100 feet and goes from west to east. The object next to Segment 1 is a tree. Segment 2 has a length of 100 feet and goes from north to south. The object next to Segment 2 is a tree. Segment 3 has a length of 100 feet and goes from east to west. The object next to Segment 3 is a tree. Segment 4 has a length of 100 feet and goes from south to north. The object next to Segment 3 is a tree.

In any event, as expressed in data format, the full lawn profile of the specific piece of lawn as shown in FIGS. 6 and 7 is as follows:

```
<LAWN ID=“100000001” TYPE=”RESIDENTIAL” MEASUREMENT=“FOOT” ZONES=“6”
AREA=“469000” D-LEVEL=“30” T-COMPLETE=“29”>
  <ADDRESS>101 Main Street</ADDRESS>
  <CITY>Ideal City</CITY>
  <STATE>Good State</STATE>
  <ZIP>99999</ZIP>
  <COUNTRY>Nice Country</COUNTRY>
  <ZONE ID=“1” STARTINGPOINT=“NORTHEAST” OBSTACLES=“0” SEGMENTS=“4”
AREA=“30000” D-LEVEL=“ 10” T-COMPLETE=“2.2”>
    < STARTINGPOINT LAT=“N 40.781200“ LNG=“W 73.966500” H= “32.8”>
    <SEGMENT ID=“1” LENGTH=“200” LAT_A=“N 40.781200“ LNG_A=“W
  73.966500“ H_A=”32.8” LAT_Z=“N 40.780650“ LNG_Z=“W 73.966500“ H_Z=”32.8”
  PROPERTY=“PAVEMENT” SLOP=“0”>
    <SEGMENT ID=“2” LENGTH=“150” LAT_A=“N 40.780650“ LNG_A=“W
  73.966500“ H_A=”32.8” LAT_Z=“N 40.780650“ LNG_Z=“W 73.967043“ H_Z=”32.8”
  PROPERTY=“CURB” SLOP=“0”>
    <SEGMENT ID=“3” LENGTH=“200” LAT_A=“N 40.780650“ LNG_A=“W
  73.967043“ H_A=”32.8” LAT_Z=“N 40.781200“ LNG_Z=“W 73.967043“ H_Z=”32.8”
  PROPERTY=“GRASS” SLOP=“0”>
    <SEGMENT ID=“4” LENGTH=“150” LAT_A=“N 40.781200“ LNG_A=“W
  73.967043“ H_A=”32.8” LAT_Z=“N 40.781200“ LNG_Z=“W 73.966500“ H_Z=”32.8”
  PROPERTY=“FENCE” SLOP=“0”>
  </ZONE>
  <ZONE ID=“2” STARTINGPOINT=“SOUTHWEST” OBSTACLES=“1”
SEGMENTS=“10” AREA=“295000” D-LEVEL=“ 60” T-COMPLETE=“17”>
    < STARTINGPOINT LAT=“N 40.781200” LNG=“W 73.967043” H=”32.8”>
    <OBSTACLE ID=“1” SEGMENTS=“4” AREA=“10000” PROPERTY=“TREE”>
      <SEGMENT ID=“1” LENGTH=“100” LAT_A=“N 40.782225“ LNG_A=“W
    73.963443“ H_A=”32.8” LAT_Z=“N 40.782225“ LNG_Z=“W
    73.963806“ H_Z=”32.8” PROPERTY=“TREE SLOP=“0”>
      <SEGMENT ID=“2” LENGTH=“100” LAT_A=“N 40.782225“ LNG_A=“W
    73.963806“ H_A=”32.8” LAT_Z=“N 40.782500“ LNG_Z=“W
    73.963806“ H_Z=”32.8” PROPERTY=“TREE SLOP=“0”>
      <SEGMENT ID=“3” LENGTH=“100” LAT_A=“N 40.782500“ LNG_A=“W
    73.963806“ H_A=”32.8” LAT_Z=“N 40.782500“ LNG_Z=“W
    73.963443“ H_Z=”32.8” PROPERTY=“TREE SLOP=“0”>
      <SEGMENT ID=“4” LENGTH=“100” LAT_A=“N 40.782500“ LNG_A=“W
    73.963443“ H_A=”32.8” LAT_Z=“N 40.782225“ LNG_Z=“W
    73.963443“ H_Z=”32.8” PROPERTY=“TREE SLOP=“0”>
    </OBSTACLE>
    <SEGMENT ID=“1” LENGTH=“550” LAT_A=“N 40.781200“ LNG_A=“W
  73.967043“ H_A=”32.8” LAT_Z=“N 40.782800“ LNG_Z=“W 73.967043“ H_Z=”32.8”
  PROPERTY=“FENCE” SLOP=“0”>
    <SEGMENT ID=“2” LENGTH=“1100” LAT_A=“N 40.782800“ LNG_A=“W
  73.967043“ H_A=”32.8” LAT_Z=“N 40.782800“ LNG_Z=“W 73.963043“ H_Z=”32.8”
  PROPERTY=“FENCE” SLOP=“0”>
    <SEGMENT ID=“3” LENGTH=“550” LAT_A=“N 40.782800“ LNG_A=“W
  73.963043“ H_Z=”32.8” LAT_Z=“N 40.781200“ LNG_Z=“W 73.963043“ H_Z=”32.8”
  PROPERTY=“FENCE” SLOP=“0”>
    <SEGMENT ID=“4” LENGTH=“200” LAT_A=“N 40.781200“ LNG_A=“W
  73.963043“ H_A=”32.8” LAT_Z=“N 40.781200“ LNG_Z=“W 73.963768“ H_Z=”32.8”
  PROPERTY=“FENCE” SLOP=“0”>
    <SEGMENT ID=“5” LENGTH=“200” LAT_A=“N 40.781200“ LNG_A=“W
  73.963768“ H_A=”32.8” LAT_Z=“N 40.781750 “ LNG_Z=“W 73.963768“ H_Z =”32.8”
  PROPERTY=“WALL” SLOP=“0”>
    <SEGMENT ID=“6” LENGTH=“50” LAT_A=“N 40.781888“ LNG_A=“W
  73.963768“ H_A=”32.8” LAT_Z=“N 40.781888“ LNG_Z=“W 73.963768“ H_Z=”32.8”
  PROPERTY=“ PAVEMENT” SLOP=“0”>
    <SEGMENT ID=“7” LENGTH=“550” LAT_A=“N 40.781888“ LNG_A=“W
  73.963768“ H_A=”32.8” LAT_Z=“N 40.781888“ LNG_Z=“W 73.965700“ H_Z=”32.8”
  PROPERTY=“PAVEMENT” SLOP=“0”>
    <SEGMENT ID=“8” LENGTH=“200” LAT_A=“N 40.781888“ LNG_A=“W
  73.965700“ H_A=”32.8” LAT_Z=“N 40.781888“ LNG_Z=“W 73.966500“ H_Z=”32.8”
  PROPERTY=“PAVEMENT” SLOP=“0”>
    <SEGMENT ID=“9” LENGTH=“250” LAT_A=“N 40.781888“ LNG_A=“W
  73.966500“ H_A=”32.8” LAT_Z=“N 40.781200“ LNG_Z=“W 73.966500“ H_Z=”32.8”
  PROPERTY=“PAVEMENT” SLOP=“0”>
    <SEGMENT ID=“10” LENGTH=“150” LAT_A=“N 40.781200“ LNG_A=“W
  73.966500“ H_A=”32.8” LAT_Z=“N 40.781200“ LNG_Z=“W 73.967043“ H_Z=”32.8”
  PROPERTY=“FENCE” SLOP=“0”>
  </ZONE>
<ZONE ID=“3” STARTINGPOINT=“SOUTHWEST” OBSTACLE=“0” SEGMENTS=“4”
  AREA=“40000” D-LEVEL=“ 10” T-COMPLETE=“3”>
    < STARTINGPOINT LAT=“N 40.780650” LNG=“W 73.963768” H=”32.8”>
    <SEGMENT ID=“1” LENGTH=“200” LAT_A=“N 40.780650“ LNG_A=“W
  73.963768“ H_A=”32.8” LAT_Z=“N 40.781200“ LNG_Z=“W 73.963768“ H_Z=”32.8”
  PROPERTY=“PAVEMENT” SLOP=“0”>
    <SEGMENT ID=“2” LENGTH=“200” LAT_A=“N 40.781200“ LNG_A=“W
  73.963768“ H_A=”32.8” LAT_Z=“N 40.781200“ LNG_Z=“W 73.963043“ H_Z=”32.8”
  PROPERTY=“FENCE” SLOP=“0”>
    <SEGMENT ID=“3” LENGTH=“200” LAT_A=“N 40.781200“ LNG_A=“W
  73.963043“ H_A=”32.8” LAT_Z=“N 40.780650“ LNG_Z=“W 73.963043“ H_Z=”32.8”
  PROPERTY=“GRASS” SLOP=“0”>
    <SEGMENT ID=“4” LENGTH=“200” LAT_A=“N 40.780650” LNG_A=“W
  73.963043“ H_A=”32.8” LAT_Z=“N 40.780650“ LNG_Z=“W 73.963768“ H_Z=”32.8”
  PROPERTY=“CURB” SLOP=“0”>
  </ZONE>
  <ZONE ID=“4” STARTINGPOINT=“SOUTHEAST” OBSTACLE=“0”
SEGMENTS=“4” AREA=“34000” D-LEVEL=“ 10” T-COMPLETE=“2.4”>
    < STARTINGPOINT LAT=“N 40.780650” LNG=“W 73.964130” H=”32.8”>
    <SEGMENT ID=“1” LENGTH=“200” LAT_A=“N 40.780650“ LNG_A=“W
  73.964130“ H_A=”32.8” LAT_Z=“N 40.781200“ LNG_Z=“W 73.964130“ H_Z=”32.8”
  PROPERTY=“PAVEMENT” SLOP=“0”>
    <SEGMENT ID=“2” LENGTH=“170” LAT_A=“N 40.781200” LNG A=“W
  73.964130“ H_A=”32.8” LAT_Z=“N 40.781200“ LNG_Z=“W 73.964747“ H_Z=”32.8”
  PROPERTY=“WALL” SLOP=“0”>
    <SEGMENT ID=“3” LENGTH=“200” LAT_A=“N 40.781200“ LNG_A=“W
  73.964747“ H_A=”32.8” LAT_Z=“N 40.780650“ LNG_Z=“W 73.964747“ H_Z=”32.8”
  PROPERTY=“PAVEMENT” SLOP=“0”>
    <SEGMENT ID=“4” LENGTH=“170” LAT_A=“N 40.780650” LNG_A=“W
  73.964747“ H_A=”32.8” LAT_Z=“N 40.780650“ LNG_Z=“W 73.964130“ H_Z=”32.8”
  PROPERTY=“CURB” SLOP=“0”>
  </ZONE>
  <ZONE ID=“5” STARTINGPOINT=“NORTHWEST” OBSTACLES=“0” SEGMENTS=“4”
AREA=“30000” D-LEVEL=“ 10” T-COMPLETE=“2.2”>
    < STARTINGPOINT LAT=“N 40.781200” LNG=“W 73.966304” H=”32.8”>
    <SEGMENT ID=“1” LENGTH=“150” LAT_A=“N 40.781200“ LNG_A=“W
  73.966304“ H_A=”32.8” LAT_Z=“N 40.781200“ LNG_Z=“W 73.965759“ H_Z=”32.8”
  PROPERTY=“FENCE” SLOP=“0”>
    <SEGMENT ID=“2” LENGTH=“200” LAT_A=“N 40.781200“ LNG_A=“W
  73.965759“ H_A=”32.8” LAT_Z=“N 40.780650“ LNG_Z=“W 73.965759“ H_Z=”32.8”
  PROPERTY=“PAVEMENT” SLOP=“0”>
    <SEGMENT ID=“3” LENGTH=“100” LAT_A=“N 40.780650“ LNG_A=“W
  73.965759“ H_A=”32.8” LAT_Z=“N 40.780650“ LNG_Z=“W 73.966304“ H_Z=”32.8”
  PROPERTY=“CURB” SLOP=“0”>
    <SEGMENT ID=“4” LENGTH=“150” LAT_A=“N 40.780650“ LNG_A=“W
  73.966304“ H_A=”32.8” LAT_Z=“N 40.781200“ LNG_Z=“W 73.966304“ H_Z=”32.8”
  PROPERTY=“PAVEMENT” SLOP=“0”>
  </ZONE>
  <ZONE ID=“6” STARTTNGPOINT=“SOUTHWEST” OBSTACLES=“0” SEGMENTS=“4”
AREA=“ 30000” D-LEVEL=“ 10” T-COMPLETE=“ 2.2”>
    < STARTINGPOINT LAT=“N 40.781200“ LNG=“W 73.966304“ H=”32.8”>
    <SEGMENT ID=“1” LENGTH=“200” LAT_A=“N 40.781200“ LNG_A=“W
  73.966304“ H_A=”32.8” LAT_Z=“N 40.781750“ LNG_Z=“W 73.966304“ H_Z=”32.8”
  PROPERTY=“PAVEMENT” SLOP=“0”>
    <SEGMENT ID=“2” LENGTH=“150” LAT_A=“N 40.781750“ LNG_A=“W
  73.966304“ H_A=”32.8” LAT_Z=“N 40.781750“ LNG_Z=“W 73.965759“ H_Z=”32.8”
  PROPERTY=“ PAVEMENT” SLOP=“0”>
    <SEGMENT ID=“3” LENGTH=“200” LAT_A=“N 40.781750“ LNG_A=“W
  73.965759“ H_A=”32.8” LAT_Z=“N 40.781200“ LNG_Z=“W 73.965759“ H_Z=”32.8”
  PROPERTY=“WALL” SLOP=“0”>
    <SEGMENT ID=“4” LENGTH=“150” LAT_A=“N 40.781200” LNG_A=“W
  73.965759“ H_A=”32.8” LAT_Z=“N 40.781200“ LNG_Z=“W 73.966304“ H_Z=”32.8”
  PROPERTY=“FENCE” SLOP=“0”>
  </ZONE>
</LAWN>
```

According to the present invention, a method of creating and processing lawn profile data, comprising the steps of: (1) collecting information or knowledge of any pieces of lawns that are necessary for performing mowing or caring jobs; (2) converting the collected information or knowledge of lawns to lawn profile data; (3) processing the lawn profile data into suitable formats and categories; (4) uploading the formatted and categorized lawn profile data to a remote storage unit and a remote information processing center; (5) updating the lawn profile data stored in the remote storage unit from time to time in response to any updates of the lawn; (6) responding and verifying a request from a user of a robotic lawn mower or lawn robot for the lawn profile data, and (7) downloading the requisite data to the user of the lawn mower or lawn robot, so that the lawn mower or lawn robot performs the desired mowing or caring jobs, in accordance with a mowing or caring job plan created on the basis of the downloaded lawn profile data designated to the specific piece of lawn to be mowed.

The present invention is described hereinabove, and is defined in the accompanying claims. However, some possible alternatives may be still available in light of the disclosure of the present invention, and should be viewed as within the spirit or scope of the present invention.

1. An information management system of lawn profile data, comprising at least one mobile device of a user being capable of receiving processed lawn profile data reflecting lawn profile information as collected from a plurality of pieces of lawns; a remote information processing center being in communication with the mobile device to receive and process requests from the mobile device for uploading the lawn profile data therefrom; wherein the remote information processing center includes a data storage unit for storing the uploaded lawn profile data for usage or application.

2. The system of claim 1, further comprising at least a lawn profile information collecting tool for collecting information and knowledge of the plurality of pieces of lawns; wherein the lawn profile information collecting tool includes a data converter for converting the collected information and knowledge of the lawns to lawn profile data; and includes a data processor for processing the lawn profile data locally into suitable formats and categories.

3. The system of claim 1, further comprising a designated robotic lawn mower to perform an authorized mowing job on a particular one of the plurality of pieces of lawns using the stored lawn profile data associated with the particular piece of lawn, if so requested.

4. The system of claim 2, wherein the lawn profile collecting tool communicates with the mobile device and transmits the processed lawn profile data thereto, thereby uploading the lawn profile data to the remote information processing center.

5. The system of claim 3, wherein the remote information processing center is capable of receiving a request from the mobile device of the user to use the designated robotic lawn mower to perform the authorized mowing job on the particular piece of lawn, verifying the request for using the designated robotic lawn mower to perform the authorized mowing job; and retrieving the associated lawn profile data from the storage unit for downloading to the designated robotic lawn mower.

6. The system of claim 1, wherein the lawn profile data is expressed in an XLM based language, that describes various properties of the plurality of pieces of lawns, including identity of a piece of lawn, zones of the lawn, segments of each zone, obstacles in the zone, and segments of each of obstacles.

7. The system of claim 1, wherein the lawn profile data includes data of lawn, data of zones, data of obstacles, and data of segments, wherein a piece of lawn is divided into a plurality zones, one or more obstacles, if any, and a plurality of segments of the zones, as well as a plurality of segments of obstacles, if any.

8. The system of claim 7, wherein said data of lawn, data of zones, data of obstacles and data of segments are in a hierarchy of lawn, zones and segments thereof, as well as obstacle and segments thereof.

9. The system of claim 3, wherein the designated robotic lawn mower senses and detects any changes of the particular pieces of lawn being mowed, and is capable of converting and processing such changes to updated lawn profile data, and transmits the updated lawn profile data to the mobile device for uploading.

10. An information management system of lawn profile data, comprising at least a lawn profile information collecting tool for collecting information and knowledge of a plurality of pieces of lawns; wherein the lawn profile information collecting tool includes a data converter for converting the collected information and knowledge of the lawns to lawn profile data, and a data processor for processing the lawn profile data locally into suitable formats and categories; at least one mobile device of a user being capable of receiving the processed lawn profile data; a remote information processing center being in communication with the mobile device to receive and process requests from the mobile device for uploading the lawn profile data therefrom; wherein the remote information processing center includes a data storage unit for storing the uploaded lawn profile data for usage or application.

11. The system of claim 10, further comprising a designated robotic lawn mower to perform an authorized mowing job on a particular one of the plurality of pieces of lawns using the stored lawn profile data associated with the particular piece of lawn, if so requested.

12. The system of claim 11, wherein the designated robotic lawn mower senses and detects any changes of the particular pieces of lawn being mowed, and is capable of converting and processing such changes to updated lawn profile data, and transmits the updated lawn profile data to the mobile device for uploading.

13. The system of claim 10, wherein the at least a lawn profile information collecting tool is used to measure and collect any information of changes of anyone of the plurality of pieces of lawns, and converts and processes the information of changes to updated lawn profile data for transmitting to the mobile device for uploading.

14. The system of claim 10, wherein the lawn profile data includes data of lawn, data of zones, data of obstacles, and data of segments, wherein a piece of lawn is divided into a plurality zones, one or more obstacles, if any, and a plurality of segments of the zones, as well as a plurality of segments of obstacles, if any.

15. The system of claim 10, wherein the lawn profile data is expressed in an XLM based language, that describes various properties of the plurality of pieces of lawns, including identity of a piece of lawn, zones of the lawn, segments of each zone, obstacles in the zone, and segments of each of obstacles.

16. The system of claim 11, wherein the designated robotic lawn mower senses and detects any changes of the particular pieces of lawn being mowed, and is capable of converting and processing such changes to updated lawn profile data, and transmits the updated lawn profile data to the mobile device for uploading.

17. A method of creating and processing lawn profile data, comprising the steps of:
(1) collecting information and knowledge of any pieces of lawns reflecting the properties of the pieces of lawns as needed for future mowing jobs;
(2) converting the collected information and knowledge of the lawns to lawn profile data;
(3) processing the lawn profile data into suitable formats and categories; and
(4) uploading the formatted and categorized lawn profile data to a remote information processing center including a storage unit for future usage.

18. The method of claim 17, further comprising the steps of updating the lawn profile data stored in the remote storage from time to time in response to any updates of any of the plurality of pieces of lawns; responding and verifying a request from a user to use the lawn profile data for a robotic lawn mower for a mowing job, and downloading the requisite data to the lawn mower to perform the mowing job.

19. The method of claim 17, wherein the lawn profile data includes data of lawn, data of zones, data of obstacles, and data of segments, and wherein any piece of lawn is divided into a plurality zones, one or more obstacles, if any, and a plurality of segments of the zones, as well as a plurality of segments of obstacles.
